(19) United States
(12) Patent Application Publication
(10) Pub. No.: US 2025/0303890 A1
(43) Pub. Date: Oct. 2, 2025

(54) VEHICLE

(71) Applicant: HONDA MOTOR CO., LTD., Tokyo (JP)

(72) Inventors: Katsuya SHIMAZAKI, Saitama (JP); Yasushi OGIHARA, Saitama (JP); Yasuo YAMADA, Saitama (JP); Shuji KAMATA, Saitama (JP)

(73) Assignee: HONDA MOTOR CO., LTD., Tokyo (JP)

(21) Appl. No.: 19/059,294

(22) Filed: Feb. 21, 2025

(30) Foreign Application Priority Data
Mar. 28, 2024 (JP) 2024-052893

(51) Int. Cl. B60L 53/16; B60L 50/51; B60L 58/19

(52) U.S. Cl. CPC B60L 53/16; B60L 50/51; B60L 58/19; B60L 2210/40; B60L 2240/30; B60L 2240/423; B60L 2240/54

(57) ABSTRACT

A vehicle includes a battery, a motor, an inverter which converts DC power to AC power, a charging terminal, an electrical device which is driven by a first voltage from the battery when the battery supplies power and is driven by the first voltage boosted by the motor and the inverter when the battery is charged at a second voltage lower than the first voltage, and a control unit which controls charging of the battery. When the battery is charged at the second voltage, the control unit selects a two-phase booster mode in a case where a stop position of a rotor of the motor is within a predetermined range in terms of an electrical angle in a stop state of the vehicle, and selects a one-phase booster mode in a case where the stop position of the rotor is outside the range in the stop state of the vehicle.

### CROSS-REFERENCE TO RELATED APPLICATIONS

This application is based on and claims priority under 35 USC 119 from Japanese Patent Application No. 2024-052893 filed on Mar. 28, 2024, the entire content of which is incorporated herein by reference.

### TECHNICAL FIELD

The present disclosure relates to a vehicle including a battery.

### BACKGROUND ART

In recent years, researches and developments have been conducted on charging and power feeding in a vehicle including a secondary battery that contributes to an increase in energy efficiency in order to allow more users to access affordable, reliable, sustainable, and advanced energy.

In relation to charging and power supply in a vehicle including a secondary battery, there are two types of charging equipment such as charging stations: a 400 V class with an upper limit voltage of 500 V, and an 800 V class with an upper limit voltage of 1000 V. When a vehicle is compatible with only the charging equipment of 400 V class or only the charging equipment of 800 V class, the vehicle cannot enjoy quick charging performance. Therefore, for example, JP7244075B describes that a series charging mode in which two batteries are connected in series, a parallel charging mode in which two batteries are connected in parallel, and a single charging mode in which any one of the two batteries is charged are switched to match a charging voltage of charging equipment.

In JP7244075B, it is described that since a motor is disposed on an electric power transmission path of the two batteries, when a charging current flows through a coil of the motor during charging, a torque is generated by the charging current, and the motor rotates.

On the other hand, JP7244075B describes that the charging is started after a rotor of the motor is moved to a zero torque position after a vehicle stops, but when moving the rotor of the motor after the vehicle is stopped, it is necessary to release a parking brake once.

However, since it is unintended for a user to release the parking brake to move the vehicle, it is preferable to avoid such a matter as much as possible.

### SUMMARY OF INVENTION

The present disclosure provides a vehicle capable of suppressing an increase in a vehicle behavior while suppressing movement of the vehicle unintended by a user in a situation where a torque is generated in a motor during charging.

An aspect of the present disclosure relates to a vehicle including:
a battery;
a motor configured to drive a wheel, and including a stator around which coils of three phases connected at a neutral point are wound and a rotor having a permanent magnet;
an inverter configured to convert DC electric power from the battery to AC electric power and supply the AC electric power to the motor;
a charging terminal connected to the battery when the battery is charged and connected to a coil of a first phase among the coils of the three phases of the motor;
an electrical device configured to be driven by a first voltage from the battery when the battery supplies power, and to be driven by the first voltage boosted by the motor and the inverter when the battery is charged at a second voltage lower than the first voltage; and
a control unit configured to control charging of the battery,
in which the control unit is configured to select, when the battery is charged at the second voltage,
   a one-phase booster mode in which a boost in voltage is performed by the inverter and a coil of a second phase or a third phase among the coils of the three phases of the motor,
   a two-phase booster mode in which a boost in voltage is performed by the inverter and coils of a second phase and a third phase among the coils of the three phases of the motor, and
the control unit is configured to:
   select the two-phase booster mode, in a case where a stop position of the rotor of the motor is within a range of 240° to 300° in terms of an electrical angle with respect to a first phase as a start point in a stop state of the vehicle; and
   select the one-phase booster mode, in a case where the stop position of the rotor of the motor is outside the range of 240° to 300° in terms of the electrical angle with respect to the first phase as the start point in the stop state of the vehicle.

According to the aspect of the present disclosure, it is possible to suppress an increase in a vehicle behavior while suppressing movement of the vehicle unintended by a user in a situation where a torque is generated in a motor during charging.

### BRIEF DESCRIPTION OF DRAWINGS

Exemplary embodiment(s) of the present invention will be described in detail based on the following figures, wherein:

FIG. 1 is a diagram showing a configuration of a charging system 1 mounted on an electric vehicle 100 according to an embodiment of the present disclosure;

FIG. 2 is a diagram showing a first voltage state (800 V start-up) of a battery 2;

FIG. 3 is a diagram showing a second voltage state (400 V start-up) of the battery 2;

FIG. 4 shows a flow of a current during traveling of the electric vehicle 100;

FIG. 5 shows a flow of a current during charging the electric vehicle 100 at a first voltage (800 V);

FIG. 6 shows a flow of a current during charging the electric vehicle 100 at a second voltage (400 V);

FIG. 7 is a schematic diagram showing a schematic configuration of the charging system 1;

FIG. 8 is a diagram showing a flow of a current at the time of two-phase boost in voltage during charging at the second voltage (400 V) of the charging system 1;

FIG. 9 is a diagram showing a flow of a current at the time of one-phase boost in voltage during charging at the second voltage (400 V) of the charging system 1;

FIG. 10 is a graph showing currents flowing through coils 32U, 32V, and 32W during traveling of the electric vehicle 100;

FIGS. 11A to 11D are diagrams showing a positional relationship between a stator 35 and a rotor 37 (permanent magnet 36) of a three-phase motor 3 shown in (A) to (D) of FIG. 10;

FIG. 12 is a diagram illustrating a specific control according to a stop angle of the rotor 37 in a charging start control during the charging at the second voltage (400 V);

FIG. 13 is an illustration diagram comparing control modes when the stop angle of the rotor 37 is 240° to 300°;

FIG. 14 is an illustration diagram comparing the control modes when the stop angle of the rotor 37 is 120° to 180° or 0° to 60°;

FIG. 15 is an illustration diagram comparing the control modes when the stop angle of the rotor 37 is 300° to 360° or 180° to 240°;

FIG. 16 is a flowchart of the charging start control during the charging at the second voltage (400 V);

FIG. 17 is a graph showing a relationship between a current change rate (di/dt) and an acceleration (G) during the charging at the second voltage (400 V);

FIG. 18 is a side view schematically illustrating the electric vehicle 100 according to the embodiment of the present disclosure; and

FIGS. 19A and 19B are diagrams illustrating a parking mechanism of the electric vehicle 100.

### DESCRIPTION OF EMBODIMENTS

Hereinafter, an electric vehicle 100 according to an embodiment of the present disclosure will be described with reference to the drawings.

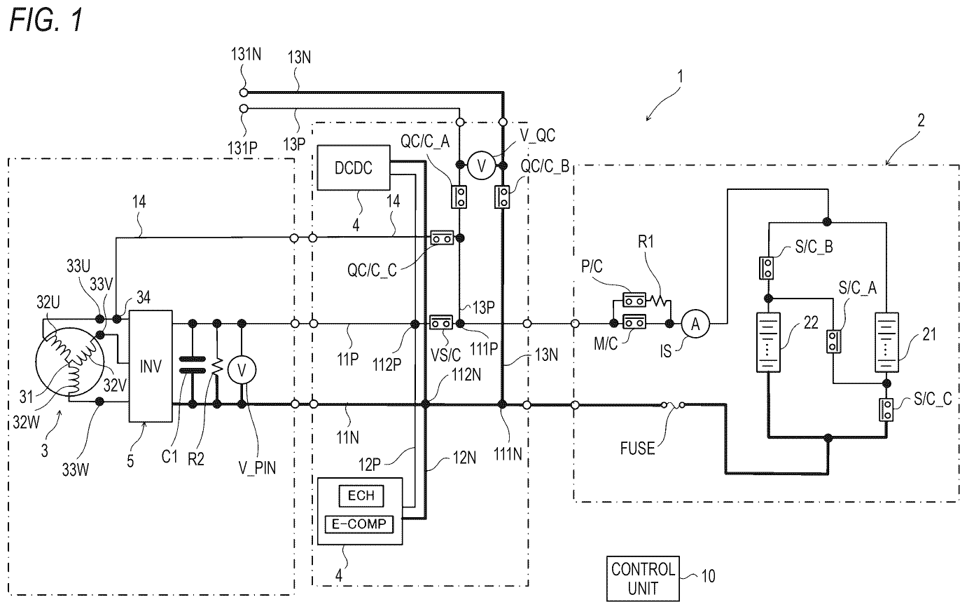

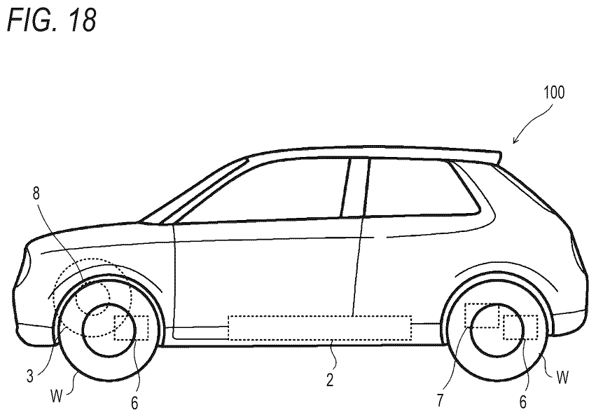

As shown in FIG. 18, the electric vehicle 100 is an electric vehicle such as an electric automobile including a charging system 1 (see FIG. 1), a hybrid automobile, or a fuel cell vehicle, and can travel by driving a three-phase motor 3 with electric power supplied from the battery 2. The electric vehicle 100 is provided with wheel brakes 6, an electric parking brake (EPB) 7 that restricts rotation of rear wheels, and a parking mechanism 8 that restricts rotation of front wheels.

Each of the wheel brakes 6 is, for example, a hydraulic brake, and applies a braking force to a wheel W according to an operation of a brake pedal by a user.

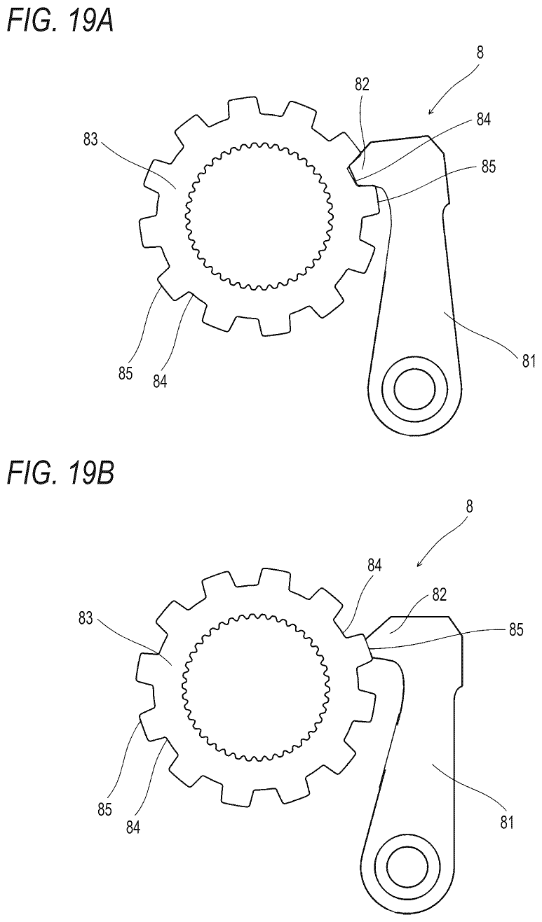

The parking mechanism 8 is in an activated state when a shift is in a parking range. During the activation of the parking mechanism 8, as shown in FIG. 19A, when a claw portion 82 of a parking pole 81 meshes with a concave portion 84 of a parking gear 83, the rotation of the parking gear 83 is restricted, and the rotation of the wheels W (front wheels) is also restricted.

The EPB 7 is controlled to an activated state and a non-activated state according to an operation of the user. Therefore, even when the electric vehicle 100 is parked, the EPB 7 may be both in the activated state and in the non-activated state.

The charging system 1 is compatible with the charging equipment of 400 V class and 800 V class. The electric vehicle can not only quickly charge the battery 2 at charging voltages of 400 V and 800 V but also drive the three-phase motor 3 and an auxiliary device 4 at a base voltage of 800 V.

Specifically, as shown in FIG. 1, the charging system 1 includes the battery 2, the three-phase motor 3, the auxiliary device 4, an inverter 5 (INV), electric power supply circuits 11P and 11N, auxiliary device drive circuits 12P and 12N, DC power supply circuits 13P and 13N, a branch circuit 14, and a control unit 10.

As shown in FIGS. 1 to 3, the battery 2 includes a first power storage unit 21, a second power storage unit 22, first to fifth contactors M/C, S/C_A, S/C_B, S/C_C, P/C, a first resistor R1, a current sensor IS, and a current breaker FUSE.

The first power storage unit 21 and the second power storage unit 22 are battery modules which can be charged and supply power at 400 V.

The first contactor M/C is provided on a positive side end of the battery 2 and functions as a main switch which turns on and off connection to the outside (electric power supply circuit 11P) of the battery 2.

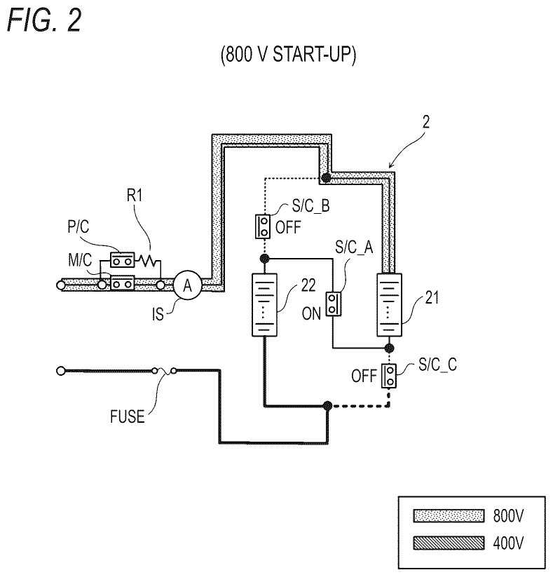

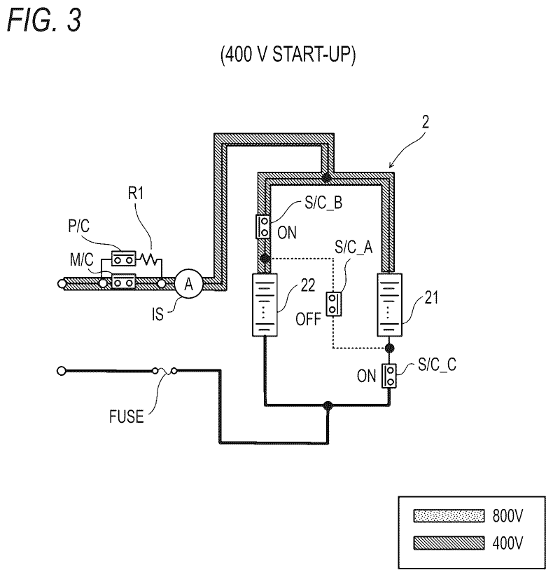

The second to fourth contactors S/C_A, S/C_B, and S/C_C switch a connection state between the first power storage unit 21 and the second power storage unit 22. For example, as shown in FIG. 2, when the second contactor S/C_A is turned on, and the third contactor S/C_B and the fourth contactor S/C_C are turned off, the battery 2 is in a first voltage state (800 V start-up) in which the first power storage unit 21 and the second power storage unit 22 are connected in series, so that the battery 2 can be charged and supply power at 800 V. As shown in FIG. 3, when the second contactor S/C_A is turned off, and the third contactor S/C_B and the fourth contactor S/C_C are turned on, the battery 2 is in a second voltage state (400 V start-up) in which the first power storage unit 21 and the second power storage unit 22 are connected in parallel, so that the battery 2 can be charged and supply power at 400 V. Note that the term start-up refers to a concept including driving during traveling of an electric vehicle including the charging system 1 and charging during parking of the electric vehicle.

The fifth contactor P/C and the first resistor R1 are arranged in series with each other and in parallel with the first contactor M/C. In the first voltage state and the second voltage state, the fifth contactor P/C is turned on before the first contactor M/C is turned on, thereby protecting the first contactor M/C from an excessive inrush current.

The current sensor IS is disposed between the first contactor M/C and the power storage units 21 and 22 to measure a current.

The current breaker FUSE is provided on a negative electrode side end of the battery 2 and cuts off the connection to the outside (electric power supply circuit 11N) of the battery 2 when an abnormality occurs. In the charging system 1 according to the present embodiment, the current breaker FUSE is implemented by a pyro-fuse which can intentionally cut off a current according to an electrical signal. When an abnormality (for example, vehicle collision or a short circuit in the battery 2) occurs, the current breaker FUSE is operated to cut off, and all the contactors in the battery 2 are turned off (opened).

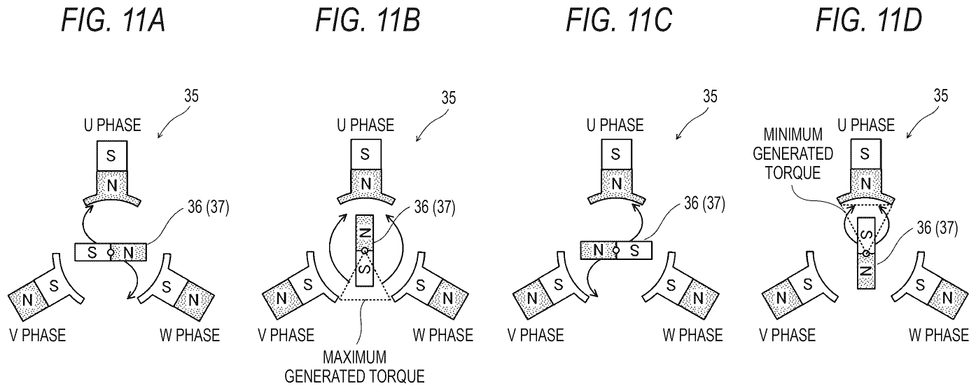

The three-phase motor 3 includes a stator 35 around which coils 32U, 32V, and 32W of three phases are wound, and a rotor 37 on which a permanent magnet 36 is disposed (see FIGS. 11A to 11D). One end side of each of the coils 32U, 32V, and 32W of the three phases is connected to a neutral point 31, and the other end side thereof is connected to the inverter 5 via a U-phase terminal 33U, a V-phase terminal 33V, and a W-phase terminal 33W, respectively. The other end side of a coil of any one phase among the coils 32U, 32V, and 32W is connected to the branch circuit 14 at a connection portion 34. In the present embodiment, the U-phase coil 32U among the coils 32U, 32V, and 32W of the three phases is connected to the branch circuit 14 at the connection portion 34 positioned between the U-phase terminal 33U and the inverter 5.

The inverter 5 converts DC electric power supplied from the battery 2 to three-phase AC electric power by switching of a plurality of switching elements, so as to rotationally drive the three-phase motor 3. As will be described in more detail later, when a DC current (400 V) is supplied from the branch circuit 14 to the connection portion 34, the inverter 5 can function as a booster circuit (DC voltage conversion portion) to boost the DC current using the coil connected to the branch circuit 14 and the coil of another one phase or another two phases, by the switching of the plurality of switching elements.

The auxiliary device 4 is an in-vehicle device that can be driven by DC electric power from the battery 2 and an external power supply, and includes, for example, an electric compressor E-COMP for an air conditioner (A/C), an electric heater ECH, and a converter DCDC for an auxiliary device. The electric compressor E-COMP and the electric heater ECH are high-voltage drive in-vehicle devices, and the converter DCDC for an auxiliary device steps down DC electric power from the battery 2 and an external power supply to drive low-voltage drive in-vehicle devices. The auxiliary device 4 is connected to the battery 2 via the auxiliary device drive circuits 12P and 12N, a sixth contactor VS/C, and the electric power supply circuits 11P and 11N. The auxiliary device 4 of the present embodiment is operated at a base voltage of 800 V while the vehicle is traveling. On the other hand, the auxiliary device 4 is capable of operating even when the voltage is not 800 V, and is configured to operate by being boosted to an efficient drive voltage during charging at 400 V described later.

The electric power supply circuits 11P and 11N are configured as a positive and negative pair and connect the battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary device drive circuits 12P and 12N (auxiliary device 4) on a side closer to the inverter 5 than the connection portions 111P and 111N. The electric power supply circuit 11P at the positive electrode side is provided with the sixth contactor VS/C which turns on and off the circuit between the connection portion 112P connected to the auxiliary device drive circuit 12P and the connection portion 111P connected to the DC power supply circuit 13P. A first voltage sensor V_PIN, a first smoothing capacitor C1, and a second resistor R2 are provided on the inverter 5 side of the electric power supply circuits 11P and 11N. The first voltage sensor V_PIN, the first smoothing capacitor C1, and the second resistor R2 are provided on a circuit that connects the electric power supply circuit 11P at the positive electrode side and the electric power supply circuit 11N at the negative electrode side. Note that the second resistor R2 is provided to discharge the first smoothing capacitor C1 when the circuit is cut off.

The DC power supply circuits 13P and 13N are configured as a positive and negative pair and include one end provided with charging terminals 131P and 131N to which an external power supply such as charging equipment can be connected and the other end connected to the electric power supply circuits 11P and 11N via the connection portions 111P and 111N. The DC power supply circuits 13P and 13N are provided with a seventh contactor QC/C_A and an eighth contactor QC/C_B for turning on and off the circuits, respectively. A second voltage sensor V_BAT is provided at a position closer to the connection portions 111P and 111N than the seventh contactor QC/C_A and the eighth contactor QC/C_B. A third voltage sensor V_QC is provided at a position closer to the charging terminals 131P and 131N than the seventh contactor QC/C_A and the eighth contactor QC/C_B.

The branch circuit 14 is branched, in the DC power supply circuit 13P at the positive side, at a position closer to the connection portion 111P than the eighth contactor QC/C_A and the second voltage sensor V_BAT, and is connected to one of the coils of the three-phase motor 3 via the connection portion 34. An intermediate portion of the branch circuit 14 is provided with a ninth contactor QC/C_C for turning on/off the circuit.

The control unit 10 is, for example, a vehicle ECU and controls driving and charging of the charging system 1. More specifically, the control unit 10 performs an ON/OFF control of the contactors M/C, S/C_A, S/C_B, S/C_C, P/C, VS/C, QC/C_A, QC/C_B, and QC/C_C, detection of welding of these contactors, control of the inverter 5, and the like.

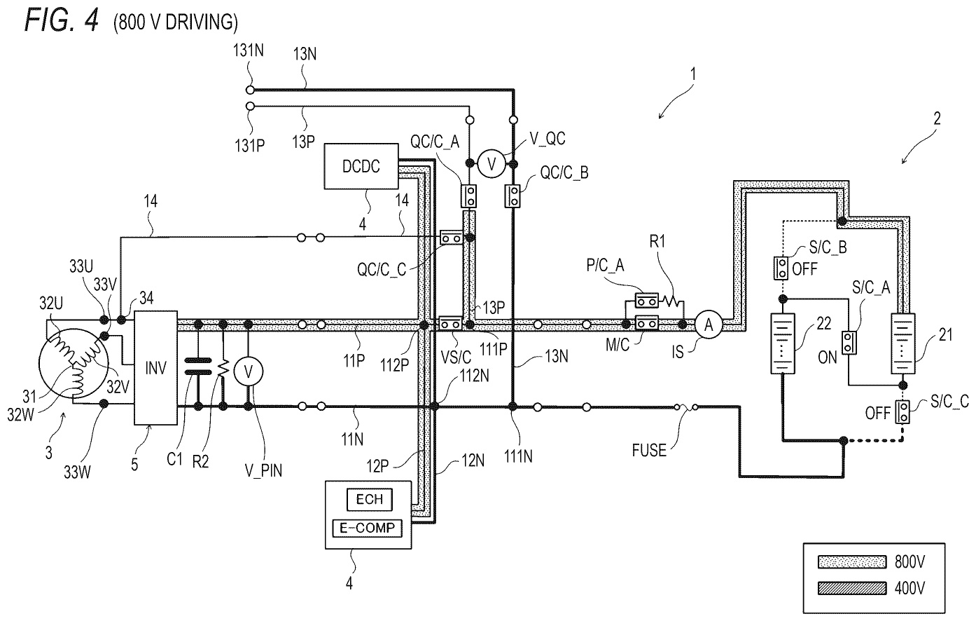

Next, an operation of the charging system I will be described with reference to FIGS. 4 to 6.

FIG. 4 is a diagram showing a flow of a current during traveling (800 V driving) of the electric vehicle including the charging system 1 according to a first embodiment.

As described above, the electric vehicle including the charging system 1 drives the three-phase motor 3 and the auxiliary device 4 at the base voltage of 800 V, and the battery 2 is controlled to an 800 V start-up state shown in FIG. 2 during the traveling. The control unit 10 turns on the first contactor M/C and the sixth contactor VS/C, and turns off the seventh contactor QC/C_A, the eighth contactor QC/C_B, and the ninth contactor QC/C_C.

In this mode, a voltage of 800 V is supplied from the battery 2 to the three-phase motor 3 via the inverter 5, enabling the electric vehicle to travel. In this case, the auxiliary device 4 is driven by a voltage of 800 V supplied from the battery 2 via the electric power supply circuits 11P and 11N and the auxiliary device drive circuits 12P and 12N.

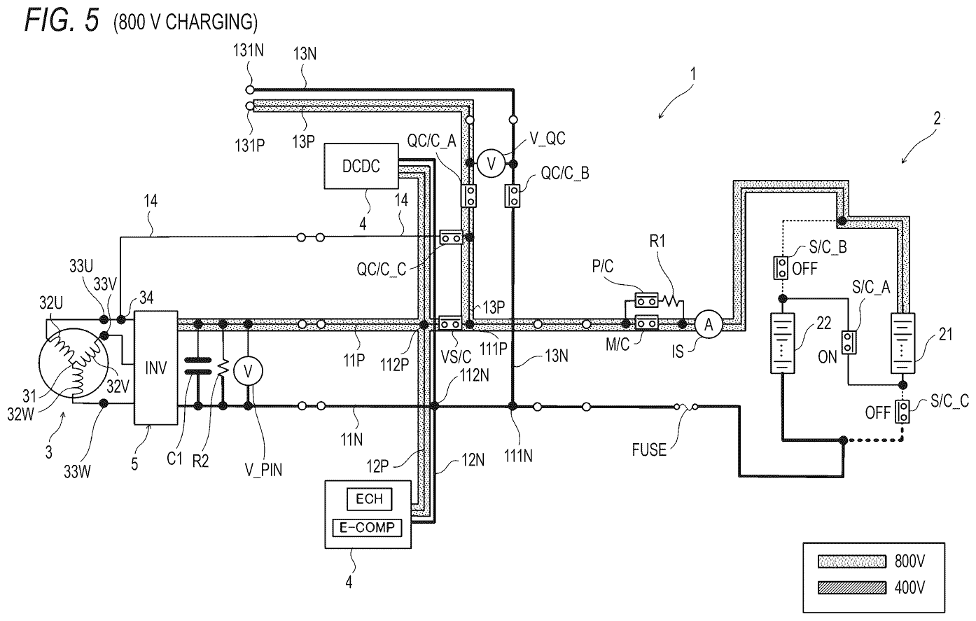

FIG. 5 is a diagram showing a flow of a current during charging at the first voltage (800 V charging) of the electric vehicle including the charging system 1 according to the first embodiment.

When charging with the charging equipment of 800 V class, the battery 2 is controlled to the 800 V start-up state shown in FIG. 2. The control unit 10 turns on the first contactor M/C, the seventh contactor QC/C_A, the eighth contactor QC/C_B, and the sixth contactor VS/C, and turns off the ninth contactor QC/C_C. Accordingly, a voltage of 800 Vis supplied from the charging terminals 131P and 131N to the battery 2, and a voltage of 800 V is supplied to the auxiliary device 4 via the electric power supply circuit 11P and the auxiliary device drive circuit 12P.

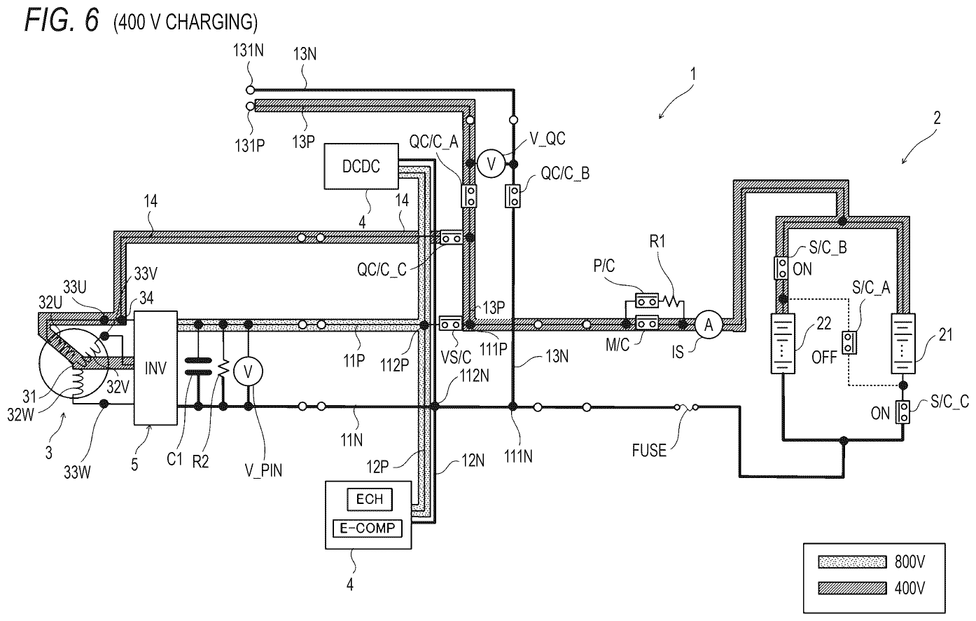

FIG. 6 is a diagram showing a flow of a current during charging at a second voltage (400 V charging) of the electric vehicle including the charging system 1 according to the first embodiment.

When charging with the charging equipment of 400 V class, the battery 2 is controlled to a 400 V start-up state shown in FIG. 3. The control unit 10 turns on the first contactor M/C, the seventh contactor QC/C_A, the eighth contactor QC/C_B, and the ninth contactor QC/C_C, and turns off the sixth contactor VS/C. Accordingly, a voltage of 400 V is supplied from the charging terminals 131P and 131N to the battery 2, and a voltage of 400 V is supplied to the U-phase coil 32U via the branch circuit 14. By turning off the sixth contactor VS/C, the power supply from the battery 2 to the auxiliary device 4 is cut off.

Here, in order to drive the auxiliary device 4 having a base voltage of 800 V, it is necessary to boost a voltage of 400 V to an auxiliary device drive voltage which is a drive voltage of an accessory of the auxiliary device 4. The auxiliary device drive voltage may be 800 V or may not be 800 V.

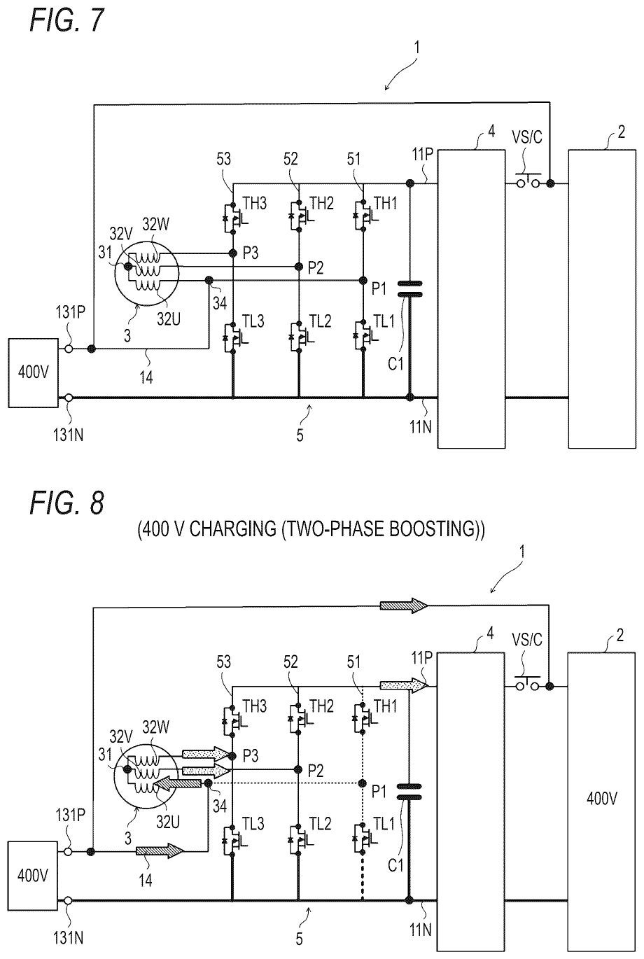

Next, a configuration of the inverter 5 and a boost operation performed by the three-phase motor 3 and the inverter 5 will be described with reference to FIGS. 7 to 9.

FIG. 7 is a schematic diagram illustrating a schematic configuration of the charging system 1 according to the first embodiment.

As shown in FIG. 7, the inverter 5 includes a first branch circuit 51 including a first high-side switch TH1, a first low-side switch TL1, and a first node P1 connecting the first high-side switch TH1 and the first low-side switch TL1 in series, a second branch circuit 52 including a second high-side switch TH2, a second low-side switch TL2, and a second node P2 connecting the second high-side switch TH2 and the second low-side switch TL2 in series, and a third branch circuit 53 including a third high-side switch TH3, a third low-side switch TL3, and a third node P3 connecting the third high-side switch TH3 and the third low-side switch TL3 in series. Each of the first branch circuit 51, the second branch circuit 52, and the third branch circuit 53 has a high-side switch side end connected in parallel with the electric power supply circuit 11P on the positive electrode side, and a low-side switch side end connected in parallel with the electric power supply circuit 11N on the negative electrode side.

The first node P1 is connected to the U-phase terminal 33U and thereby connected to the U-phase coil 32U, the second node P2 is connected to the V-phase terminal 33V and thereby connected to the V-phase coil 32V, and the third node P3 is connected to the W-phase terminal 33W and thereby connected to the W-phase coil 32W. Note that the switches TH1, TL1, TH2, TL2, TH3, and TL3 are implemented by, for example, MOSFETs, whose opening and closing control is performed by the control unit 10 by adjusting a gate voltage.

A diode operating as a reflux diode is connected in parallel with each of the switches TH1, TL1, TH2, TL2, TH3, and TL3. The reflux diodes are provided to prevent damage to the switching elements by causing a current flowing back from a motor 3 side to reflux (regenerate) to a battery 2 side when the switches TH1, TL1, TH2, TL2, TH3, and TL3 are turned off. That is, the inverter 5 allows a current to flow from the three-phase motor 3 side to the battery 2 side regardless of an ON or OFF state of a gate, and allows a current to flow from the battery 2 side to the three-phase motor 3 side only when the gate is in an ON state.

When charging is performed with the charging equipment of 400 V class, the control unit 10 controls the charging system 1 to a state shown in FIG. 6. Accordingly, a voltage of 400 V is supplied from the charging terminals 131P and 131N to the battery 2, and a voltage of 400 V is supplied to the U-phase coil 32U via the branch circuit 14. The power supply from the battery 2 to the auxiliary device 4 is cut off, and thus it is necessary to boost the voltage of 400 V to the auxiliary device drive voltage of the auxiliary device 4 in order to drive the auxiliary device 4. In the following description, the boosted voltage corresponding to the auxiliary device drive voltage may be referred to as a secondary voltage.

FIG. 8 is a diagram showing a flow of a current at the time of two-phase boost in voltage during charging at the second voltage (400 V) of the charging system 1 according to the first embodiment.

Therefore, in the state shown in FIG. 6, the control unit 10 performs high-frequency switching of the second low-side switch TL2 and the third low-side switch TL3 to perform a booster operation of switching between ON states of the second low-side switch TL2 and the third low-side switch TL3 and OFF states of the second low-side switch TL2 and the third low-side switch TL3. Note that the other switches TL1 and TH1 to TH3 of the inverter 5 are maintained in the OFF state.

Accordingly, the energy stored in the coils 32U, 32V, and 32W when the second low-side switch TL2 and the third low-side switch TL3 are in the ON state is released when the second low-side switch TL2 and the third low-side switch TL3 are in the OFF state, so that the voltage of 400 V supplied from the charging terminals 131P and 131N is boosted to the secondary voltage and supplied from the inverter 5 to the auxiliary device 4. Hereinafter, such a booster operation state performed by the three-phase motor 3 and the inverter 5 is referred to as a two-phase booster mode.

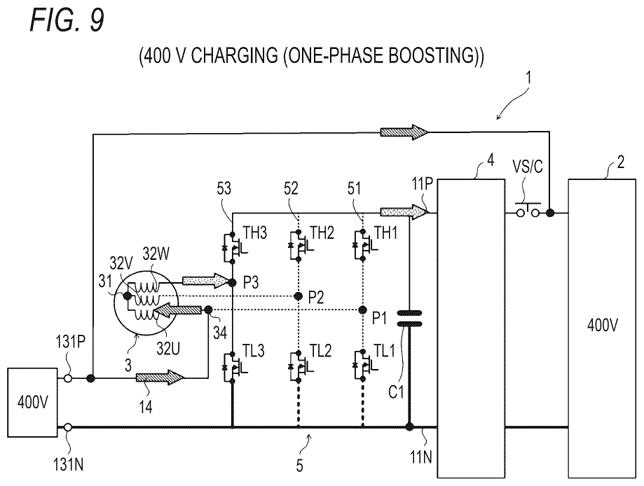

FIG. 9 is a diagram showing a flow of a current at the time of one-phase boost in voltage during charging at the second voltage (400 V) of the charging system 1 according to the first embodiment.

In the state shown in FIG. 6, the control unit 10 performs high-frequency switching of the third low-side switch TL3 to perform a booster operation of switching between the ON state of the third low-side switch TL3 and the OFF state of the third low-side switch TL3. Note that the other switches TL1, TL2, and TH1 to TH3 of the inverter 5 are maintained in the OFF state.

Accordingly, the energy stored in the coils 32U and 32W when the third low-side switch TL3 is in the ON state is released when the third low-side switch TL3 is in the OFF state, so that the voltage of 400 V supplied from the charging terminals 131P and 131N is boosted to the secondary voltage and supplied from the inverter 5 to the auxiliary device 4. Hereinafter, such a booster operation state performed by the three-phase motor 3 and the inverter 5 is referred to as a one-phase booster mode.

In the electric vehicle 100, when the electric power supplied to the auxiliary device 4 is boosted in voltage in the two-phase booster mode or the one-phase booster mode during charging at the second voltage (400 V), currents flow through the coils 32U, 32V, and 32W to generate a magnetic field, and a torque is generated in the three-phase motor 3. Therefore, according to the circumstances, the rotor 37 may rotate, and the wheels W connected to the rotor 37 may also rotate when the rotor 37 rotates.

Magnitude of the torque generated in the three-phase motor 3 at the time of two-phase boost in voltage and one-phase boost in voltage changes according to a stop angle (stop position) of the rotor 37 during the parking of the electric vehicle 100.

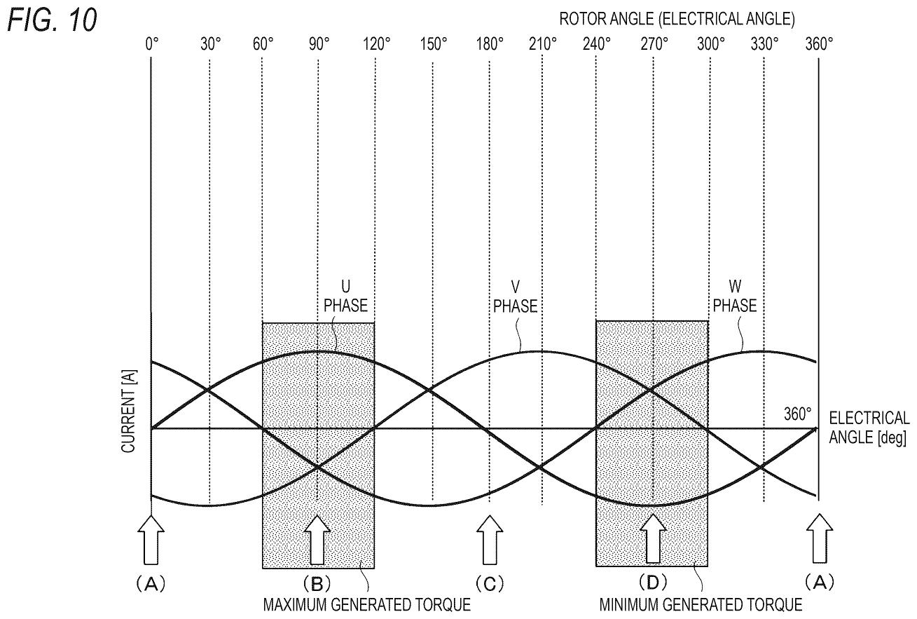

FIG. 10 is a graph showing currents flowing through the coils 32U, 32V, and 32W during traveling of the electric vehicle 100, and FIGS. 11A to 11D are diagrams showing a positional relationship between the stator 35 and the rotor 37 (permanent magnet 36) of the three-phase motor 3 shown in (A) to (D) of FIG. 10. FIGS. 10 and 11A to 11D show a motor having two poles and three slots as the three-phase motor 3.

For example, as shown in FIGS. 10 and 11A to 11D, based on the currents flowing through the coils 32U, 32V, and 32W during traveling of the electric vehicle 100, when a direction where a U-phase current is + is defined as a positive direction of an electrical angle with respect to a position where the U-phase current is zero, the V-phase current is negative, and the W-phase current is positive as 0° (start point) in terms of the electrical angle as shown in (A) of FIG. 10 and FIG. 11A, the torque generated in the three-phase motor 3 is maximum at an electrical angle of 90° shown in (B) of FIG. 10 and FIG. 11B, and the torque generated in the three-phase motor 3 is minimum at an electrical angle of 270° shown in (D) of FIG. 10 and FIG. 11D. Hereinafter, a region of an electrical angle of 60° to 120° of +30° around the electrical angle of 90° is referred to as a generated torque maximum region, and a region of an electrical angle of 240° to 300° of +30° around the electrical angle of 270° is referred to as a generated torque minimum region.

Here, in a case where the parking mechanism 8 changes from the non-activated state to the activated state, as shown in FIG. 19B, when the claw portion 82 of the parking pole 81 abuts a convex portion 85 of the parking gear 83, the parking gear 83 can be rotated until the claw portion 82 of the parking pole 81 meshes with the concave portion 84 of the parking gear 83, and the wheels W are also rotatable accordingly. The EPB 7 is controlled to the activated state and the non-activated state according to an operation of the user.

Therefore, even when the claw portion 82 of the parking pole 81 abuts the convex portion 85 of the parking gear 83 during parking of the electric vehicle 100, the rotation of the wheels W is restricted when the user sets the EPB 7 to the activated state. On the other hand, when the user does not set the EPB 7 in the activated state while the claw portion 82 of the parking pole 81 abuts the convex portion 85 of the parking gear 83 during parking of the electric vehicle 100, the parking gear 83 can be rotated until the claw portion 82 of the parking pole 81 meshes with the concave portion 84 of the parking gear 83, and if the battery 2 is charged at the second voltage (400 V) in this state, the wheels W may be rotated by the torque generated in the three-phase motor 3.

When the claw portion 82 of the parking pole 81 meshes with the concave portion 84 of the parking gear 83 to restrict the rotation of the parking gear 83 during parking of the electric vehicle 100, and when the user sets the EPB 7 to the activated state while the claw portion 82 of the parking pole 81 abuts the convex portion 85 of the parking gear 83, the movement of the electric vehicle 100 in a front-rear direction is restricted, and in particular, in the latter case, the torque generated in the three-phase motor 3 may cause the electric vehicle 100 to swing in an upper-lower direction.

Therefore, in order to restrict the movement and the swing of the electric vehicle 100 during charging at the second voltage (400 V), the control unit 10 changes a charging mode according to the position of the rotor 37 during parking of the electric vehicle 100, in other words, according to the torque that can be generated in the three-phase motor 3. In the following description, a case where the electric vehicle 100 can be moved in the front-rear direction will be described as an example.

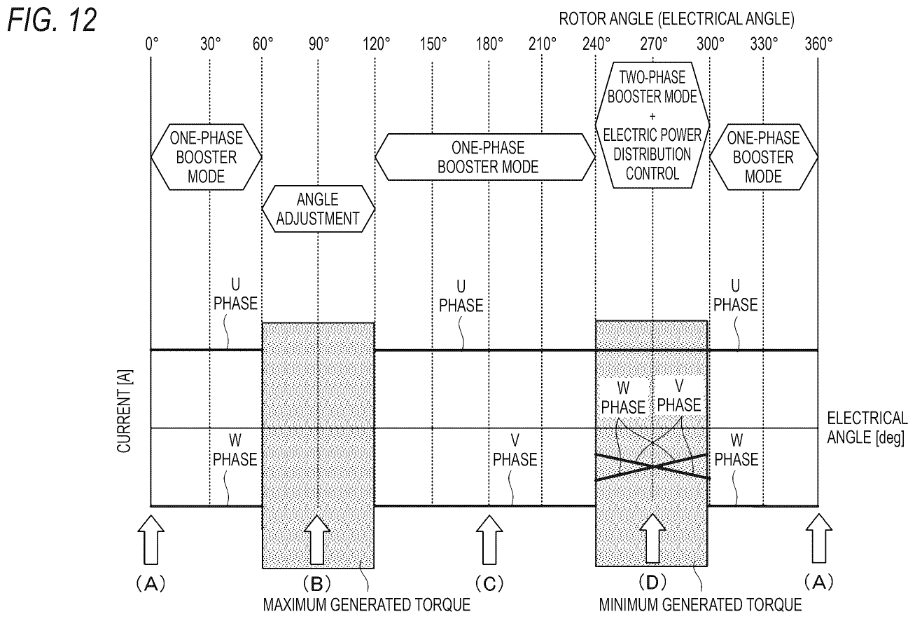

FIG. 12 is a diagram illustrating a specific control according to the stop angle of the rotor 37 in the charging start control during charging at the second voltage (400 V).

Specifically, as shown in FIG. 12, when the stop angle of the rotor 37 during parking of the electric vehicle 100 is in the range of 240° to 300° in terms of the electrical angle, that is, in the generated torque minimum region, the control unit 10 selects the two-phase booster mode and performs an electric power distribution control. Hereinafter, all angles are assumed to be electrical angles.

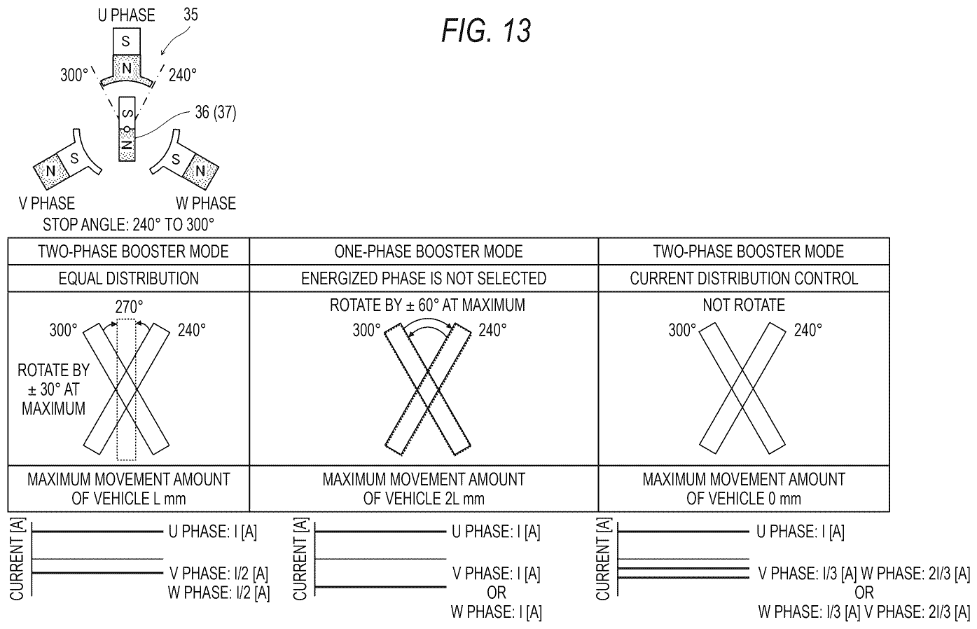

As shown in a right diagram of FIG. 13, a current distribution control is a control for adjusting the distribution of the current flowing through the V-phase coil 32V and the current flowing through the W-phase coil 32W so as to maintain the stop angle of the rotor 37, while maintaining a relationship in which a sum of the current flowing through the V-phase coil 32V and the current flowing through the W-phase coil 32W is equal to the current flowing through the U-phase coil 32U. For example, when the stop angle of the rotor 37 is 240°, the current flowing through the U-phase coil 32U is set to I [A], the current flowing through the V-phase coil 32V is set to 2I/3 [A], and the current flowing through the W-phase coil 32W is set to I/3 [A]. When the stop angle of the rotor 37 is 270°, the current flowing through the V-phase coil 32V is set to I/2 [A], and the current flowing through the W-phase coil 32W is set to I/2 [A]. When the stop angle of the rotor 37 is 300°, the current flowing through the V-phase coil 32V is set to I/3 [A], and the current flowing through the W-phase coil 32W is set to 2I/3 [A]. Accordingly, the torque generated in the three-phase motor 3 at each angular position becomes zero, and the position of the rotor 37 can be fixed, and a movement amount of the electric vehicle 100 can be set to zero (0 mm).

On the other hand, for example, as shown in a left diagram of FIG. 13, when the two-phase booster mode is selected and the current flowing through the V-phase coil 32V and the current flowing through the W-phase coil 32W are equally distributed to be equal to each other (U phase: I/2 [A], V phase: I/2 [A]), the rotor 37 rotates to the position of 270°, and therefore, the rotor 37 rotates by ±30° when the stop angle of the rotor 37 is 240° or 300°. Therefore, when the movement amount of 30° of the rotor 37 is L (mm), the electric vehicle 100 moves by L (mm) at the maximum.

For example, as shown in a middle diagram of FIG. 13, when the one-phase booster mode is selected, the rotor 37 rotates from the position of 240° to the position of 300° or from the position of 300° to the position of 240°, so that the rotor 37 rotates by +60° at the maximum, and the electric vehicle 100 moves by 2 L (mm) at the maximum.

Therefore, when the stop angle of the rotor 37 during parking of the electric vehicle 100 is in the range of 240° to 300° in terms of the electrical angle, that is, in the generated torque minimum region, the control unit 10 can suppress the electric vehicle 100 from moving in the front-rear direction by selecting the two-phase booster mode during charging at the second voltage (400 V).

In the two-phase booster mode, the movement amount of the electric vehicle 100 can be reduced to zero by distributing the current flowing through the V-phase coil 32V and the current flowing through the W-phase coil 32W such that the rotor 37 of the three-phase motor 3 stops.

Returning to FIG. 12, next, when the stop angle of the rotor 37 during parking of the electric vehicle 100 is in the range of 60° to 120° in terms of the electrical angle, that is, in the generated torque maximum region, the control unit 10 rotates the rotor 37 to be outside the range before the battery 2 is charged. That is, when the stop angle of the rotor 37 is in the range of 60° to 120° in terms of the electrical angle, the rotor 37 is rotated such that the rotor 37 is rotated to 60° or 120° which is closer, and the electric vehicle 100 is moved before the battery 2 is charged.

The maximum angle at which the rotor 37 is rotated is obtained in a case where the stop angle of the rotor 37 is 90°, and in this case, the rotor 37 is rotated 30°. The movement amount of the electric vehicle 100 in this case, is L (mm) at the maximum.

Since the movement of the electric vehicle 100 is not intended by the user, it is preferable that the movement is not recognized by the user. Therefore, for example, when the brake pedal is shifted from the ON state to the OFF state, the parking mechanism 8 is not set to the non-activated state, and a control of rotating the rotor 37 is performed. After the rotor 37 is rotated to the position closer to the position of 60° or 120°, the same is applied to a case where the stop angle of the rotor 37 is 0° to 60° or 120° to 180°.

Returning to FIG. 12, when the stop angle of the rotor 37 during parking of the electric vehicle 100 is 0° to 60° or 120° to 180° in terms of the electrical angle, the control unit 10 selects the one-phase booster mode and performs an energized phase selection control of selecting a phase in which the rotation of the rotor 37 is minimum out of the V phase and the W phase.

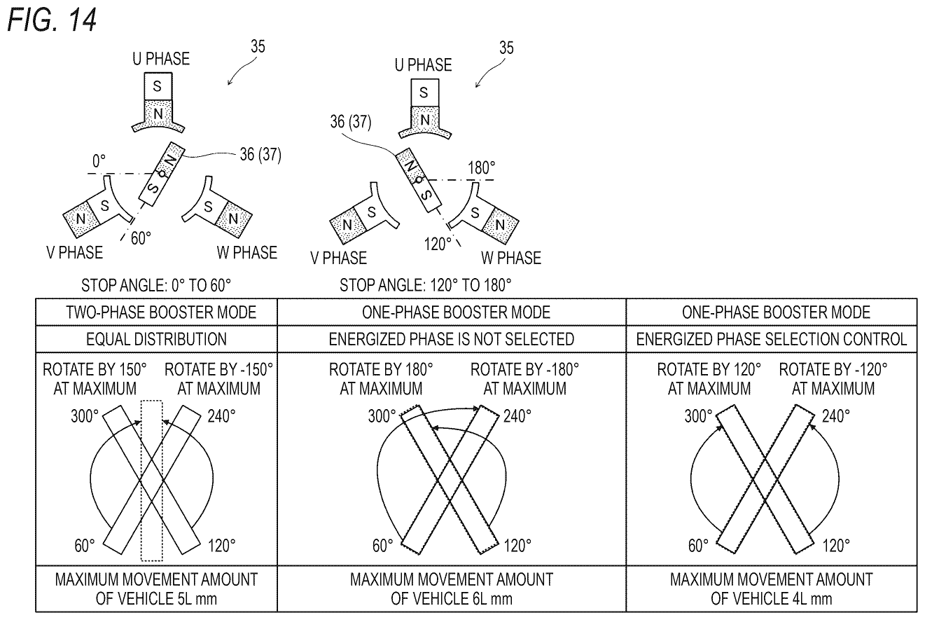

As shown in a right diagram of FIG. 14, the control unit 10 selects the phase in which the rotation of the rotor 37 is minimum out of the V phase and the W phase, in the energized phase selection control. For example, when the stop angle of the rotor 37 is 120°, the rotor 37 is rotated counterclockwise to a position of 240° such that the rotation of the rotor 37 is the minimum and is positioned in the generated torque minimum region. Accordingly, the rotor 37 rotates 120°, and the electric vehicle 100 moves 4 L (mm) at the maximum. When the stop angle of the rotor 37 is 60°, the rotor 37 is rotated clockwise to a position of 300° such that the rotation of the rotor 37 is minimum and is positioned in the generated torque minimum region. Accordingly, the rotor 37 rotates by 120° at the maximum, and the electric vehicle 100 moves by 4 L (mm) at the maximum.

On the other hand, for example, as shown in a left diagram of FIG. 14, when the two-phase booster mode is selected and the current flowing through the V-phase coil 32V and the current flowing through the W-phase coil 32W are equally distributed to be equal to each other (U phase: I/2 [A], V phase: I/2 [A]), the rotor 37 rotates to the position of 270°, and therefore, the rotor 37 rotates by ±150° when the stop angle of the rotor 37 is 120° or 240°. Therefore, the electric vehicle 100 moves by 5 L (mm) at the maximum.

For example, as shown in a middle diagram of FIG. 14, if the one-phase booster mode is selected and the energized phase is not appropriately selected, the rotor 37 rotates from the position of 120° to the position of 300° or from the position of 60° to the position of 240°, and thus the rotor 37 rotates by ±180° at the maximum, and the electric vehicle 100 moves by 6 L (mm) at the maximum.

Therefore, when the stop angle of the rotor 37 during parking of the electric vehicle 100 is 0° to 60° or 120° to 180° in terms of the electrical angle, the control unit 10 can suppress the electric vehicle 100 from moving in the front-rear direction by selecting the one-phase booster mode during charging at the second voltage (400 V) and performing the energized phase selection control of selecting the phase in which the rotation of the rotor 37 is minimum.

Returning to FIG. 12, when the stop angle of the rotor 37 during parking of the electric vehicle 100 is 180° to 240° or 300° to 360° in terms of the electrical angle, the control unit 10 selects the one-phase booster mode and performs the energized phase selection control of selecting the phase in which the rotation of the rotor 37 is minimum out of the V phase and the W phase.

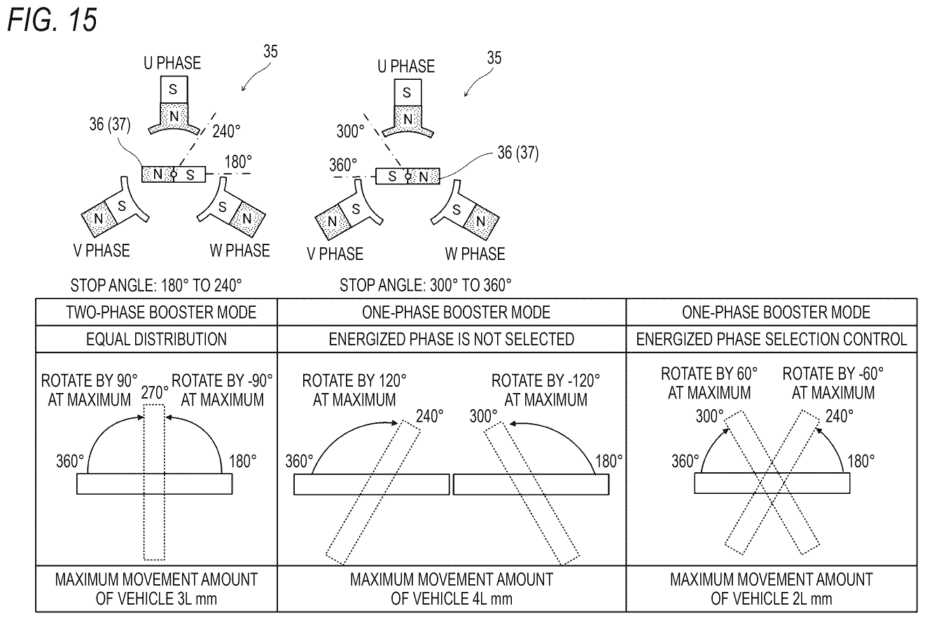

As shown in a right diagram of FIG. 15, the control unit 10 selects the phase in which the rotation of the rotor 37 is minimum out of the V phase and the W phase, in the energized phase selection control. For example, when the stop angle of the rotor 37 is 180°, the rotor 37 is rotated counterclockwise to a position of 240° such that the rotation of the rotor 37 is minimum and is positioned in the generated torque minimum region. Accordingly, the rotor 37 rotates by 60°, and the electric vehicle 100 moves 2 L (mm) at the maximum. When the stop angle of the rotor 37 is 360° (0°), the rotor 37 is rotated clockwise to the position of 300° such that the rotation of the rotor 37 is minimum and is positioned in the generated torque minimum region. Accordingly, the rotor 37 rotates by 60° at the maximum, and the electric vehicle 100 moves by 2 L (mm) at the maximum.

On the other hand, for example, as shown in a left diagram of FIG. 15, when the two-phase booster mode is selected and the current flowing through the V-phase coil 32V and the current flowing through the W-phase coil 32W are equally distributed to be equal to each other (U phase: I/2 [A], V phase: I/2 [A]), the rotor 37 rotates to the position of 270°, and therefore, when the stop angle of the rotor 37 is 180° or 360° (0°), the rotor 37 rotates by ±90°. Therefore, the electric vehicle 100 moves by 3 L (mm) at the maximum.

For example, as shown in a middle diagram of FIG. 15, if the one-phase booster mode is selected and the energized phase is not appropriately selected, the rotor 37 rotates from the position of 180° to the position of 300° or from the position of 360° (0°) to the position of 240°, and thus the rotor 37 rotates by +120° at the maximum, and the electric vehicle 100 moves by 4 L (mm) at the maximum.

Therefore, when the stop angle of the rotor 37 during parking of the electric vehicle 100 is 180° to 240° or 300° to 360° (0°) in terms of the electrical angle, the control unit 10 can suppress the electric vehicle 100 from moving in the front-rear direction by selecting the one-phase booster mode during charging at the second voltage (400 V) and performing the energized phase selection control of selecting the phase in which the rotation of the rotor 37 is minimum.

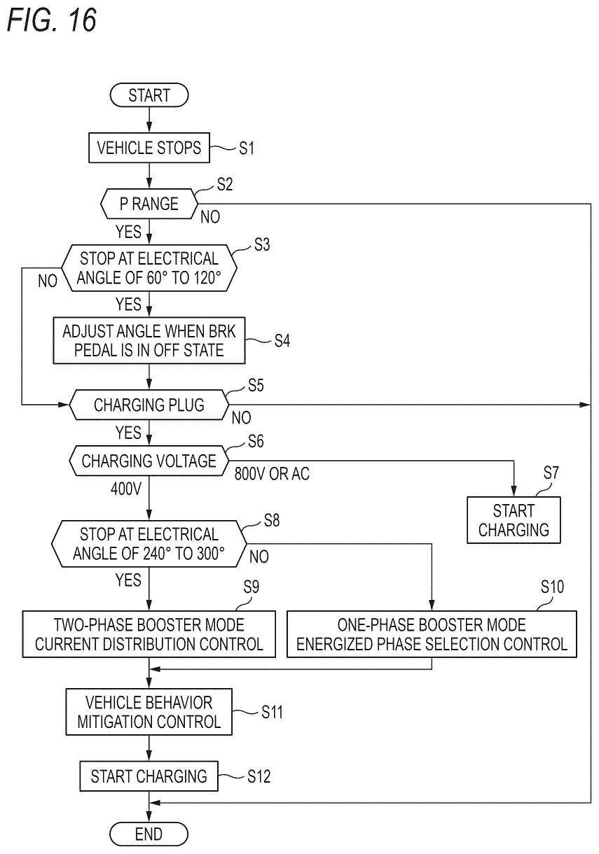

FIG. 16 is a flowchart of the charging start control during charging at the second voltage (400 V).

First, the control unit 10 detects a stop state of the electric vehicle 100 (step S1). Subsequently, the control unit 10 detects whether a shift is in a parking range (P range) (step S2). As a result, when the shift is not in the parking range (P range) (NO in step S2), it is determined that the electric vehicle 100 is in the stop state and the user does not intend to perform the charging, and the process ends.

If the shift is in the parking (P range) (YES in step S2), the control unit 10 detects whether the stop angle of the rotor 37 is in the range of 60° to 120° in terms of the electrical angle. As a result, when the stop angle of the rotor 37 is in the range of 60° to 120° in terms of the electrical angle, the rotor 37 is rotated when the brake pedal (BRK pedal) is in the OFF state, and the stop angle of the rotor 37 is set to 60° or 120°. When the claw portion 82 of the parking pole 81 meshes with the concave portion 84 of the parking gear 83 to restrict the rotation of the parking gear 83, and when the user sets the EPB 7 to the activated state while the claw portion 82 of the parking pole 81 abuts the convex portion 85 of the parking gear 83, there is a possibility that the rotor 37 cannot be rotated and cannot escape from the range of 60° to 120° in the electric angle.

When the stop angle of the rotor 37 is not 60° to 120° in terms of the electrical angle (NO in step S3), and when the control is performed to adjust the stop angle by rotating the rotor 37 (S4), the control unit 10 detects whether a charging plug is fitted to the charging terminals 131P and 131N (step S5).

When the charging plug is not fitted to the charging terminals 131P and 131N (NO in step S5), it is determined that the user does not intend to perform the charging, and the process ends. On the other hand, when the charging plug is fitted to the charging terminals 131P and 131N, the control unit 10 communicates with the charging equipment to detect the charging voltage on a charging equipment side (step S6).

As a result, when the charging voltage is 800 V or when the charging is AC charging, the booster control using the coils 32U, 32V, 32W of the three-phase motor 3 is not performed, and thus no torque is generated in the three-phase motor 3, and the electric vehicle 100 does not move. Therefore, the charging is started as it is (step S7).

On the other hand, when the charging voltage on the charging equipment side is 400 V, the control unit 10 detects whether the stop angle of the rotor 37 is in the range of 240° to 300° (step S8). As a result, when the stop angle of the rotor 37 is in the range of 240° to 300° (YES in step S8), the two-phase booster mode is selected as described in the right diagram of FIG. 13, and the current distribution control is performed (step S9). When the stop angle of the rotor 37 is not in the range of 240° to 300° (NO in step S8), the one-phase booster mode is selected as described in the right diagrams of FIGS. 14 and 15, and the energized phase selection control is performed (step S10).

Here, as described above, when the torque is generated in the three-phase motor 3, the electric vehicle 100 may move in the front-rear direction or swing in the upper-lower direction.

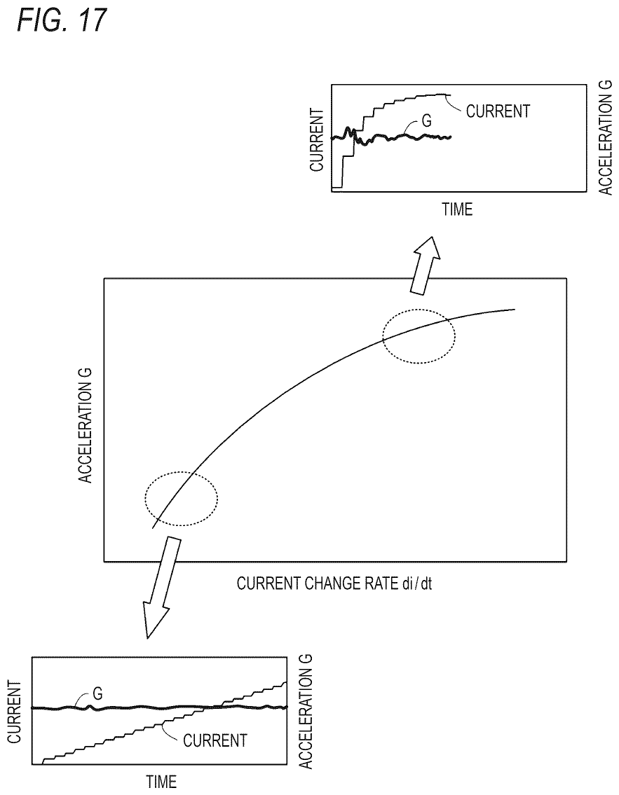

FIG. 17 is a graph showing a relationship between a current change rate (di/dt) and an acceleration (G) during charging at the second voltage (400 V).

As shown in FIG. 17, when the current change rate (di/dt) obtained by differentiating an output current (i) during charging at the second voltage (400 V) with respect to a time (t) is large, the acceleration G becomes large, and a vehicle behavior becomes large. Therefore, the control unit 10 performs a vehicle behavior mitigation control such that the current change rate becomes equal to or less than a predetermined value (step S11) when the one-phase boost in voltage or two-phase boost in voltage is performed to boost the voltage to 800 V during charging at the second voltage (400 V), and starts the charging (step S12). By controlling the current change rate during the charging at the second voltage (400 V) to be equal to or less than a predetermined value in this manner, the behavior of the electric vehicle 100 can be mitigated.

Although the various embodiments have been described above with reference to the drawings, it is needless to say that the present invention is not limited to these examples. It is apparent that those skilled in the art can conceive of various modifications and changes within the scope described in the claims, and it is understood that such modifications and changes naturally fall within the technical scope of the present invention. In addition, respective constituent elements in the above-described embodiment may be freely combined without departing from the gist of the invention.

In this specification, at least the following matters are described. Although corresponding constituent elements or the like in the embodiment described above are shown in parentheses, the present invention is not limited thereto.
(1) A vehicle (electric vehicle 100) including:
a battery (battery 2);
a motor (three-phase motor 3) configured to drive a wheel (wheel W), and including a stator (stator 35) around which coils (coils 32U, 32V, 32W) of three phases connected at a neutral point (neutral point 31) are wound and a rotor (rotor 37) having a permanent magnet (permanent magnet 36);
an inverter (inverter 5) configured to convert DC electric power from the battery to AC electric power and supply the AC electric power to the motor;
a charging terminal (charging terminal 131P) connected to the battery when the battery is charged and connected to a coil (U-phase coil 32U) of a first phase (U phase) among the coils of the three phases of the motor;
an electrical device (auxiliary device 4) configured to be driven by a first voltage (800 V) from the battery when the battery supplies power, and to be driven by the first voltage boosted by the motor and the inverter when the battery is charged at a second voltage (400 V) lower than the first voltage; and
a control unit (control unit 10) configured to control charging of the battery,
in which the control unit is configured to select, when the battery is charged at the second voltage,
   a one-phase booster mode in which a boost in voltage is performed by the inverter and a coil (V-phase coil 32V or W-phase coil 32W) of a second phase (V phase) or a third phase (W phase) among the coils of the three phases of the motor,
   a two-phase booster mode in which a boost in voltage is performed by the inverter and coils of the second phase and the third phase among the coils of the three phases of the motor, and
the control unit is configured to:
   select the two-phase booster mode, in a case where a stop position of the rotor of the motor is within a range of 240° to 300° in terms of an electrical angle with respect to a first phase as a start point in a stop state of the vehicle; and
   select the one-phase booster mode, in a case where the stop position of the rotor of the motor is outside the range of 240° to 300° in terms of the electrical angle with respect to the first phase as the start point in the stop state of the vehicle.

When the battery is charged at the second voltage lower than the first voltage which is a drive voltage of the electrical device, and the motor and the inverter boost the voltage to the first voltage, a torque is generated in the motor. According to (1), by selecting the booster mode according to the stop position of the rotor in the stop state of the vehicle, the vehicle can be suppressed from moving in a front-rear direction.
(2) The vehicle according to (1),
in which in a case where the stop position of the rotor of the motor is within a range of 60° to 120° in terms of the electrical angle with respect to the first phase as the start point when the vehicle stops, the control unit is configured to rotate the rotor to be outside the range before the battery is charged.

According to (2), when the vehicle stops in an angular range in which the torque generated in the motor is large, by rotating the rotor before the charging, it is possible to reduce the movement of the vehicle during the charging.
(3) The vehicle according to (1),
in which in a case where the stop position of the rotor of the motor is within a range of 0° to 60°, 120° to 240°, or 300° to 360° in terms of the electrical angle with respect to the first phase as the start point when the vehicle stops, the control unit is configured to select the one-phase booster mode and select a phase in which a rotation of the rotor is minimum out of the second phase and the third phase.
According to (3), it is possible to reduce the movement of the vehicle during the charging.
(4) The vehicle according to any one of (1) to (3),
in which a connecting and disconnecting device (sixth contactor VS/C) is provided on an electric power transmission path between the battery and the electrical device, and
when the battery is charged at the second voltage, the connecting and disconnecting device cuts off electric power transmission between the battery and the electrical device.

According to (4), when the battery is charged at the second voltage, it is possible to prevent the second voltage from charging equipment from being supplied to the electrical device driven by the first voltage.
(5) The vehicle according to (1),
in which the control unit is configured to control a current change rate to be equal to or less than a predetermined value in the one-phase booster mode.

According to (5), it is possible to reduce a vehicle behavior during the movement of the vehicle.
(6) The vehicle according to (2),
in which in a case where a parking mechanism is in activation and a brake pedal is in an ON state, and the stop position of the rotor is within the range of 60° to 120° in terms of the electrical angle with respect to the first phase as the start point,
the control unit is configured to perform a control for rotating the rotor without setting the parking mechanism to a non-activated state when the brake pedal is shifted from the ON state to an OFF state.

According to (6), it is possible to reduce the feeling of discomfort of a user by moving the vehicle unintentionally by the user when the brake pedal is shifted from the ON state to the OFF state.
(7) The vehicle according to (6),
in which a rotation of the rotor is 30° at maximum in terms of the electrical angle.

According to (7), it is possible to shift to a chargeable state with the minimum movement.
(8) The vehicle according to (1),
in which in the two-phase booster mode, the control unit is configured to distribute a current flowing through the coil of the second phase and a current flowing through the coil of the third phase such that the rotor of the motor stops.

According to (8), by adjusting the currents flowing through the two phases according to the position of the rotor, the torque generated in the motor can be suppressed, and the movement of the vehicle can be suppressed.

What is claimed is:

1. A vehicle comprising:
a battery;
a motor configured to drive a wheel, and including a stator around which coils of three phases connected at a neutral point are wound and a rotor having a permanent magnet;
an inverter configured to convert DC electric power from the battery to AC electric power and supply the AC electric power to the motor;
a charging terminal connected to the battery when the battery is charged and connected to a coil of a first phase among the coils of the three phases of the motor;
an electrical device configured to be driven by a first voltage from the battery when the battery supplies power, and to be driven by the first voltage boosted by the motor and the inverter when the battery is charged at a second voltage lower than the first voltage; and
a control unit configured to control charging of the battery,
wherein the control unit is configured to select, when the battery is charged at the second voltage,
a one-phase booster mode in which a boost in voltage is performed by the inverter and a coil of a second phase or a third phase among the coils of the three phases of the motor,
a two-phase booster mode in which a boost in voltage is performed by the inverter and coils of a second phase and a third phase among the coils of the three phases of the motor, and
the control unit is configured to:
select the two-phase booster mode, in a case where a stop position of the rotor of the motor is within a range of 240° to 300° in terms of an electrical angle with respect to a first phase as a start point in a stop state of the vehicle; and
select the one-phase booster mode, in a case where the stop position of the rotor of the motor is outside the range of 240° to 300° in terms of the electrical angle with respect to the first phase as the start point in the stop state of the vehicle.

2. The vehicle according to claim 1,
wherein in a case where the stop position of the rotor of the motor is within a range of 60° to 120° in terms of the electrical angle with respect to the first phase as the start point when the vehicle stops, the control unit is configured to rotate the rotor to be outside the range before the battery is charged.

3. The vehicle according to claim 1,
wherein in a case where the stop position of the rotor of the motor is within a range of 0° to 60°, 120° to 240°, or 300° to 360° in terms of the electrical angle with respect to the first phase as the start point when the vehicle stops, the control unit is configured to select the one-phase booster mode and select a phase in which a rotation of the rotor is minimum out of the second phase and the third phase.

4. The vehicle according to claim 1,
wherein a connecting and disconnecting device is provided on an electric power transmission path between the battery and the electrical device, and
when the battery is charged at the second voltage, the connecting and disconnecting device cuts off electric power transmission between the battery and the electrical device.

5. The vehicle according to claim 1,
wherein the control unit is configured to control a current change rate to be equal to or less than a predetermined value in the one-phase booster mode.

6. The vehicle according to claim 2,
wherein in a case where a parking mechanism is in activation and a brake pedal is in an ON state, and the stop position of the rotor is within the range of 60° to 120° in terms of the electrical angle with respect to the first phase as the start point,
the control unit is configured to perform a control for rotating the rotor without setting the parking mechanism to a non-activated state when the brake pedal is shifted from the ON state to an OFF state.

7. The vehicle according to claim 6,
wherein a rotation of the rotor is 30° at maximum in terms of the electrical angle.

8. The vehicle according to claim 1,
wherein in the two-phase booster mode, the control unit is configured to distribute a current flowing through the coil of the second phase and a current flowing through the coil of the third phase such that the rotor of the motor stops.
